(19) United States
(12) Patent Application Publication
(10) Pub. No.: US 2014/0180741 A1
(43) Pub. Date: Jun. 26, 2014

(54) SYSTEM AND METHOD FOR AUTOMATIC ALLOCATION OF MOBILE RESOURCES TO TASKS

(71) Applicant: ABB Technology AG, Zurich (CH)

(72) Inventors: Carsten Franke, Stetten (CH); Iiro Harjunkoski, Weinheim (DE); Sleman Saliba, Heidelberg (DE)

(73) Assignee: ABB Technology AG, Zurich (CH)

(21) Appl. No.: 14/136,454

(22) Filed: Dec. 20, 2013

(30) Foreign Application Priority Data
Dec. 20, 2012 (EP) 12198470.2

(51) Int. Cl. G06Q 10/06

(52) U.S. Cl. CPC G06Q 10/063112; G06Q 10/06315
USPC 705/7.14

(57) ABSTRACT

A system for automatic allocation of mobile resources to tasks includes at least one database which stores for each mobile resource at least one corresponding skill and equipment as well as street-level data defining roads between a current location of the mobile resources and the distant locations of the tasks, and dynamic data which have a potential impact on performance of the tasks. A first data processing unit allocates the mobile resources to the tasks by allocating the skills to the tasks and the equipment, and generates for at least one of the mobile resources an individual schedule including a street-by-street route along the roads to the respectively allocated tasks. A second data processing unit continuously pre-processes the dynamic data to determine which of the street-level data, the mobile resources and the tasks are affected by the dynamic data and to what extent, and to amend the affected data accordingly.

### RELATED APPLICATIONS

This application claim priority under 35 U.S.C. §119 to European Patent Application No. 12198470.2 filed in Europe on Dec. 20, 2012, the entire content of which is hereby incorporated by reference in its entirety.

### FIELD

The present disclosure relates to a system and a method for automatic allocation of mobile resources to tasks which are to be performed at at least one location distant from the mobile resources.

### BACKGROUND INFORMATION

There are various systems on the market for automatic allocation of mobile resources to tasks, such as Service Suite by Ventyx® and Clickmobile® by ClickSoftware®.

The term “task” refers to any kind of maintenance, service or repair work to be performed at a technical installation either on an industrial site, or in private homes or a municipal infrastructure, where the technical installations may belong, for example, to the utilities industry, such as gas, electric, water or telecommunications utilities.

Accordingly, the term “mobile resource” refers to field operation teams equipped to perform the above described tasks.

In known systems for automatic allocation of mobile resources to tasks, a data processing unit of a computing device performs the allocation after having been triggered by a trigger event, where the trigger event can be generated either periodically by a clock, or aperiodically by a user or system input requesting a re-allocation or re-scheduling.

The schedules are the output generated by the data processing unit, wherein the schedules include information on which mobile resource shall perform which tasks in which given sequence at what specified times during a day. Since the tasks are usually to be performed at different geographic locations, the schedules further include a route which is given as a sequence of the geographic locations corresponding to the sequence of allocated tasks. When generating the schedules, the travel time between the geographic locations is commonly taken into account as the estimated time needed to cover the length of a straight line between respective two of the geographic locations.

Commonly, a long-term schedule is generated first for each field operation team, which usually covers the next working day, but can as well relate to the next working week. Afterwards, re-scheduling of the long-term schedule is adapted to take into account the changes in influencing factors, such as sick leave of a technician or breaking-down of the car of a field operation team, thereby generating a corresponding short-term schedule. In known systems, the changes in the influencing factors are at least partly handled manually; that is, the short-term schedules are not the result of a fully automated re-allocation but of man-made adjustments in the long-term schedules. Accordingly, short-term schedules are usually not optimal. All of the above-named schedules fall under the term “individual schedule”, where “individual” means that the mobile resources are allocated to a respective schedule which is adjusted to their corresponding availability.

The individual schedules are each transmitted to a mobile data communication device assigned to the respective one of the mobile resources, which commonly is a handheld device.

As a result of the ever-growing competition on the utilities market and due to an increase in the diversity of utilities and energy resources and, therefore, in the technical complexity and failure proneness of utility networks and home installations, time and resource efficiency as well as reliability of the schedules are becoming more important. Accordingly, there is a current trend towards improving the quality and practicability of the schedules.

This is, for example, achieved by introducing a demand forecasting element in the above named systems for automatic allocation of mobile resources to tasks, where the number and extent of future tasks, i.e. the future field work demand, is predicted based on experiences learned from past events and based on, for example, a weather forecast as an external factor.

For example, it is suggested in US 2009/0171718 A1 to provide a work load modeling system to be used by a communication network service provider. The work load modeling system is configured to dynamically forecast a workload based on information corresponding to a workforce, a current workload, historical workloads, and one or more factors influencing the workload, for example, weather and geographic locality, where these input data are provided as user input data and from various external data management systems, such as a workforce management system and a ticket system. The modeling system can provide a prediction report to a user or it can alert a workforce as to real-time variations in a workload that necessitate revisions to workforce scheduling.

### SUMMARY

An exemplary embodiment of the present disclosure provides a system for automatic allocation of mobile resources to tasks which are to be performed at at least one location distant from the mobile resources. The exemplary system includes at least one database configured to store data defining the tasks as well as the mobile resources, and a computing device containing a first data processing unit. The first data processing unit is configured to wait for a trigger event. After having been notified of the trigger event, the first data processing unit is configured to access the at least one database, allocate the mobile resources to the tasks to generate an individual schedule for at least one of the mobile resources, and transmit each of the individual schedules to a mobile data communication device assigned to the respective one of the mobile resources. The at least one database is configured to store at least one corresponding skill and equipment for each mobile resource, street-level data defining roads between a current location of the mobile resources and the at least one distant location of the tasks, and dynamic data which have a potential impact on the performing of the tasks. The first data processing unit is configured to perform the allocation of the mobile resources by allocating the skills to the tasks and to the equipment, and to generate for the at least one of the mobile resources, as part of each individual schedule, a street-by-street route along the roads to the respectively allocated tasks. The exemplary system also comprises a second data processing unit implemented in one of the computing device and a further computing device, the second data processing unit being configured to continuously pre-process the dynamic data to determine which of the street-level data, the mobile resources and the tasks are affected by the dynamic data and to what extent, and to amend the affected data accordingly.

An exemplary embodiment of the present disclosure provides a method for computer-implemented automatic allocation of mobile resources to tasks which are to be performed at at least one location distant from the mobile resources. The exemplary method includes storing data defining the tasks as well as the mobile resources in at least one database, and waiting for a trigger event by a first data processing device. After having been notified of the trigger event, the first data processing device accesses the at least one database, allocates the mobile resources to the tasks to generate an individual schedule for at least one of the mobile resources, and transmits each of the individual schedules to a mobile data communication device assigned to the respective one of the mobile resources. The exemplary method also includes storing in the at least one database at least one corresponding skill and equipment for each mobile resource, street-level data defining roads between a current location of the mobile resources and the at least one distant location of the tasks, and dynamic data which have a potential impact on the performing of the tasks. In addition, the exemplary method includes performing, in the first data processing device, the allocating of the mobile resources by allocating the skills to the tasks and to the equipment, and by generating for the at least one of the mobile resources as part of each individual schedule a street-by-street route along the roads to the allocated tasks. Furthermore, the exemplary method includes continuously pre-processing, in a second data processing device, the dynamic data to determine which of the street-level data, the mobile resources and the tasks are affected by the dynamic data and to what extent, and to amend the affected data accordingly.

### BRIEF DESCRIPTION OF THE DRAWINGS

Additional refinements, advantages and features of the present disclosure are described in more detail below with reference to exemplary embodiments illustrated in the drawings, in which:

FIG. 1 illustrates a system for automatic allocation of mobile resources to tasks, according to an exemplary embodiment of the present disclosure; and

FIG. 2 illustrates a graphic representation of street-level data, according to an exemplary embodiment of the present disclosure.

### DETAILED DESCRIPTION

Exemplary embodiments of the present disclosure provide an improved system and method for automatic allocation of mobile resources to tasks so that the practicability and reliability of the generated schedules are increased in order to be able to react more precisely to real-time events. This is, for example, advantageous in connection with emergencies occurring on a technical installation requiring immediate countermeasures, so that a black-out of an electricity network can be avoided, for example.

Exemplary embodiments of the present disclosure provide a system for the automatic allocation of mobile resources to tasks which are to be performed at at least one location distant from the mobile resources, and a method for computer-implemented automatic allocation of mobile resources to tasks which are to be performed at at least one location distant from the mobile resources.

The exemplary system includes at least one database configured to store data defining the tasks as well as the mobile resources, and a computing device containing a first data processing unit. The first data processing unit is configured to wait for a trigger event. After having been notified of the trigger event, the first data processing unit is configured to access the at least one database, allocate the mobile resources to the tasks to generate an individual schedule for at least one of the mobile resources, and transmit each of the individual schedules to a mobile data communication device assigned to the respective one of the mobile resources.

In the exemplary system according to the present disclosure, the at least one database is configured to store at least one corresponding skill and equipment for each mobile resource, street-level data defining roads between a current location of the mobile resources and the distant locations of the tasks, and dynamic data which have a potential impact on the performing of the tasks.

Further, the first data processing unit of the system is configured to perform the allocating of the mobile resources by allocating the skills to the tasks and to the equipment, and to generate for the at least one of the mobile resources as part of each individual schedule a street-by-street route along the roads to the respectively allocated tasks.

An advantageous feature of the present disclosure is the provision of a second data processing unit which can be implemented either in the computing device or in another computing device. The second data processing unit is configured to continuously pre-process the dynamic data in order to determine which of the street-level data, the mobile resources and the tasks are affected by the dynamic data and to what extent, and to amend the affected data accordingly.

In accordance with an exemplary embodiment, the first and second data processing units can be implemented by a computing device such as computer having at least one processor (e.g., a general-purpose processor such as those produced by Intel® or AMD®, for example, or an application specific processor), a non-transitory computer-readable recording memory which is a non-transitory memory (e.g., ROM, hard disk drive, optical memory, flash memory, etc.) for tangibly recording thereon a computer program or computer-readable instructions that, when executed by the at least one processor, cause the first and second data processing units to perform the functions and features described herein. The computing devices respectively embodying the first and second data processing units can also include a working memory such as a RAM or other memory that can be used by the respective processors to assist in executing the operative functions and features of the exemplary embodiments described herein.

Exemplary embodiments of the present disclosure are based on the following string of considerations and ideas. First, to use street-level data, for example, street map data, to determine for each schedule a street-by-street route, so that a more realistic and precise travel time is calculated by the first data processing unit based on a more realistic calculation of distances between geographic locations of the tasks. Second, to further increase the reliability of the travel times by taking into account dynamic data which can influence the travel times along the street-by-street routes, such as weather forecast data. Third, to not only take into account forecast data, but also dynamic data which contain information on a sudden change of an influencing factor to the travel times or, more generally, to the performing of the tasks and thereby to the schedules, such as data on traffic jams. Fourth, to avoid further extension of the known resource allocation systems by not simply adding a further data processing module for the handling of traffic-related information, but to create a simplified system structure by reducing and limiting the main elements of the resource allocation system to two data processing units, where one data processing unit performs the actual allocation and the other data processing unit prepares all relevant input data to the allocation algorithms and stores them in a mutually accessible database, and by defining and establishing an invariable data interface between the two data processing units in the form of a fixed set of input data to the resource allocation.

As a result, a system structure is generated with which any additional kind of dynamic and real-time data influencing the performing of the tasks can be taken into account by the resource allocation without having to adapt and change the resource allocation processing unit, for example, the first data processing unit, and its algorithms. Accordingly, any influencing factor which can jeopardize the execution of the allocated tasks and which therefore can result in problematic consecutive faults of the technical installation to be repaired, for example, can easily be integrated into the resource allocation system, so that the quality and precision of the schedules is easily improved and adapted to the current needs.

Further, since the second data processing unit pre-processes the dynamic data continuously, the input data to the first data processing system are always kept up-to-date, so that it is guaranteed that any triggered re-scheduling is based on the most recent information. An even further advantage is that the first and second data processing units can be operated asynchronously, for example, on a triggered basis versus continuously, as the database allows for an independent and asynchronous access to the stored data, so that the first data processing unit can deliver an updated schedule as quickly as possible without having to wait for the second data processing unit.

According to an exemplary embodiment of the present disclosure, the fixed set of input data to the resource allocation contains data defining the skills and equipment describing the mobile resources, as well as the street-level data and the data defining the tasks. The second data processing unit amends (e.g., modifies or updates) these input data continuously in order to reflect the impact of the dynamic data, so that a subsequently generated schedule and street-by-street route are adjusted to any changes in the conditions for reaching the next task location in time and for performing the next task.

In the system and method according to the present disclosure, the term “mobile resources” is clearly defined to refer to both human resources, for example, the field operation teams, as well as their technical equipment, where the field operation teams may include one to several engineers and/or technicians and where the technical equipment includes vehicles, for example, cars and vans, with which the teams are transported to the technical installations, as well as any computer device, tool, material and instrument needed for performing the tasks. Accordingly, a schedule assigned to a mobile resource can be either assigned to a specific field operation team or to a specific vehicle belonging to the respective field operation team. As a result, the transmission of the assigned schedule is either performed to a handheld device, such as a smart phone or a personal digital assistant, carried by a member of the field operation team, or to a data communication and data visualization unit attached to the vehicle of the field operation team. It is to be noted that the field operation team does not necessarily always have to travel by car. Instead, it can travel independently of the equipment, such as when a truck delivers all parts and tools in the early morning to an area which is expected to be overcrowded during the day, and where the technicians follow later by automobile, public transport or bicycle, for example.

The mobile resources are defined by their skills and by assignable equipment. The term “skill” refers to both the knowledge and capabilities of the field engineers and field technicians as well as those skills which are the result of a fixed assignment of a certain type of equipment to the respective engineer or technician, such as a particularly equipped car or device. The term “equipment” includes everything of computer devices, tools, material and instruments which is freely assignable to any or at least among a part of the field engineers and technicians.

The term “road” refers to any trafficable, public or, if applicable, private road which can be taken by a common vehicle.

The term “pre-process” refers to any kind of data analysis with which information can be extracted from the dynamic data to be able to determine and assess the impact of the dynamic data on the fixed set of input data to the first processing unit. The pre-processing can, for example, be performed on the dynamic data by filtering, error-detection, statistical analysis—for example machine learning, pattern recognition, regression and correlation analysis—, model fitting and parameter identification.

In accordance with an exemplary embodiment of the present disclosure, the second data processing unit is configured to introduce a logical link between at least two of the skills, equipment, roads and/or tasks. The first data processing unit is configured to perform the allocating so that the logically linked data are reflected in the individual schedule. This is a possible extension of the fixed set of input data to the first data processing unit, thereby marking those of the input data who are a preferred combination or, in the alternative, the only possible combination of the input data as a result of the dynamic data.

In accordance with an exemplary embodiment, the street-level data can contain for each of the roads speed-related information corresponding to a specified section of the road. The first data processing unit is configured to generate the individual schedule and the corresponding street-by-street route by minimizing a length of travel time and/or a travel distance per unified time window while maximizing the number of allocated tasks per the unified time window.

The speed-related information may be, for example, represented by a speed profile of expected average speed per road section or by street-map data including speed limits which are valid along the road sections. The unified time window can be defined as a couple of hours, a whole day or the length of a shift or task. When maximizing the number of allocated tasks, it is of course assumed that most or all of the tasks can as well be finished during the time frame allocated to them in the generated schedule.

The dynamic data can advantageously include data from a traffic control center about traffic jams, accidents and/or construction sites, and the second data processing unit can then be configured to identify the roads which are affected by the data from the traffic control center and the extent to which the street-level data corresponding to the identified roads are affected and to adjust the corresponding street-level data, for example, the speed-related information, accordingly. For example, in case that speed-related information per road or road section is used, this information can be amended by the second data processing unit towards an expected average speed of zero km/h, thereby forcing the first data processing unit to avoid these roads.

The database can be configured to store the dynamic data over a pre-defined period of time, and the second data processing unit can then be configured to identify from the dynamic data a time-dependent pattern of traffic intensity along the roads and to amend the street-level data to reflect the pattern of traffic intensity by adjusting the speed-related information accordingly. For example, the traffic pattern can indicate the variations of the expected average speed of a road or road section over a working day or depending on the day of the week.

The dynamic data can further include data of a traffic related public event, such as vacations, concerts, marathons, street festivals etc. In that case, the second data processing unit can be configured to estimate the impact of the event on the speed-related information and to identify those roads which will be blocked for any traffic during the event. Here again, the speed-related information for the identified roads in the database will be adjusted accordingly.

In accordance with an exemplary embodiment, the dynamic data can include weather related data, the second data processing unit can be configured to correspondingly adjust the speed-related information of affected roads and/or a priority ranking of the equipment and/or skills, and the first data processing unit can accordingly be configured to perform the allocating so that the priority ranking is reflected in the individual schedule. For example, in case of ice or snow, it can be advisable to not let the field operation teams take minor roads, as they may not be snow-plowed. This can again be implemented by changing the expected average speed to zero. In general, during expected or currently occurring bad weather conditions, the expected average speed per road can be decreased, and it can be increased when the weather is good. An example for a priority ranking of equipment would be to give cars with winter tires a higher priority in case of snow. An example for prioritizing of skill would be to let the best drivers take the tasks furthest away or the most urgent tasks, which means not only to give good driving skills the highest priority ranking, but in addition to link the good driving skills to the furthest away or most urgent tasks.

In accordance with an exemplary embodiment, the dynamic data include data on the availability of fuel and/or electricity, for example in the form of a report about a power outage or black-out. In this embodiment, the second data processing unit is configured to adapt a priority ranking of the tasks and/or of fuel- or electricity driven equipment to the respective availability. For example, electric cars should not be taken into a black-out zone when they are expected to require re-charging. Alternatively, the priority ranking of tasks can take into account, whether the respective task can be fulfilled in an area where there is no fuel and/or electricity available or whether the respective task should be given the highest possible priority as its fulfillment will solve the power outage problem.

In accordance with an exemplary embodiment of the resource allocation system, the second data processing unit is configured to predict future tasks based on the dynamic data and the first or second data processing unit is configured to define an appropriate emergency reserve of mobile resources capable of responding to the predicted tasks. The emergency reserve of mobile resources can, for example, be given the lowest priority ranking so that no or only the least important tasks are assigned to them, or they can be linked to tasks which can be interrupted at short notice without any problem.

In accordance with an exemplary embodiment, the dynamic data can include an update on a state of a mobile resource, and the second data processing unit can be configured to determine a resulting impact on any of the skills and/or equipment. For example, if a car or van of one of the field operation teams has run out of certain equipment, the person or persons assigned to the car can be stripped of corresponding skills, such as the ability to perform specific testing or measuring. Alternatively, a logical link between the car and the field operation team can be cancelled by the second data processing unit, and the car can be given the lowest possible priority ranking in order to allow for the first data processing unit to re-allocate the team to a different car. In a further example, a field technician can report a broken arm. As a result, the second data processing unit would adapt his or her skills accordingly, for example, removing a skill for climbing and for dealing with intricate tools.

The embodiments of the method for automatic allocation of mobile resources to tasks include all the steps performed by the elements and units contained in the above-described system.

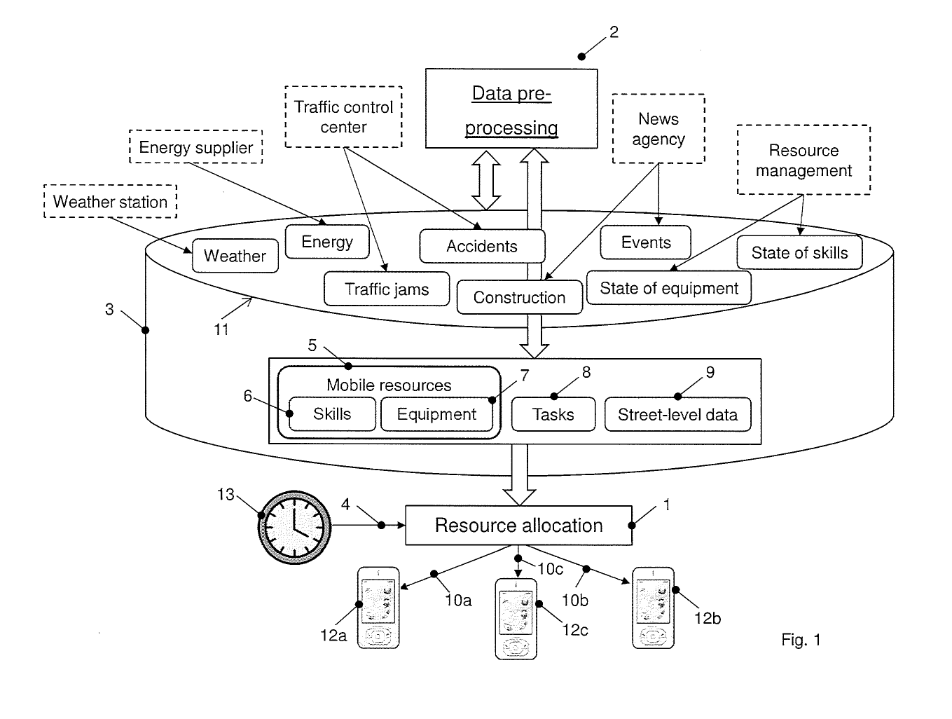

In FIG. 1, a system for automatic allocation of mobile resources to tasks is shown which, according to an exemplary embodiment of the present disclosure, includes a database 3 which can be any information collecting device, which is file-based and memory resident with the capacity to store the needed information and to provide it to other devices. The database 3 is configured to store data defining the tasks 8 as well as the mobile resources 5, where the data defining the mobile resources contain for each mobile resource 5 at least one corresponding skill 6 and at least one corresponding equipment 7. For the sake of clarity, it is pointed out that the plural terms used throughout this description, such as tasks, skills etc., shall always refer to at least two of the respective items.

The database 3 is further configured to store street-level data 9 which define roads between a current location of the mobile resources 5 and the locations of the tasks 8, wherein it is assumed that the locations of the tasks 8 are geographically distant from the location of the mobile resources 5 so that the mobile resources 5 have to be transported to the locations of the tasks 8. Even further, the database 3 is configured to store dynamic data 11 which have a potential impact on the performing of the tasks 8, where in the example shown in FIG. 1, the dynamic data can be provided by information systems of external data sources, such as manual services, automatic public information or targeted service companies who maintain up-to-date information.

In the following, examples of the dynamic data of FIG. 1 and their sources are listed: a weather station can provide weather forecast data as well as data on current weather conditions, including, for example, storms, temperatures, precipitation and ice-conditions; a supplier of energy, where energy is understood in terms of fuel and/or electricity, can provide data on the availability of fuel and/or electricity, for example on power cuts; a traffic control center can transmit the most recent information on accidents and traffic jams, where the transmission can be nation-wide by radio frequency; a local news agency can deliver reliable data on public events and on currently installed construction sites; and a resource management system can provide information which affect the state of skills 6 and equipment 7, such as that a travel distance took longer than anticipated, that the current task turns out to be a difficult assignment, specific technical information, or complexities occurring during execution of a task.

The system further includes a first computing device containing a first data processing unit 1 (e.g., at least one processor and/or processing circuitry), where the first data processing unit 1 is configured to wait for a trigger event 4, which in the example of FIG. 1 is a clock 13 sending out two different trigger events 4: one at least 24 hours in advance to initiate generation of a long-term schedule, and one before starting of the respective shift to initiate a re-scheduling in order to take the latest changes in the tasks 8, such as order completions, cancellations, and additions, as well as the latest dynamic data 11 into account.

The first processing unit 1 is further configured to—after having been notified of the trigger event 4—access the at least one database 3, to allocate the skills 6 to the tasks 8 and to the equipment 7 thereby generating for at least one of the mobile resources 5, which are, in this example, three different field operation teams, an individual schedule 10a, 10b, 10c and—as part of each individual schedule 10a, 10b, 10c—a street-by-street route along the roads to the respectively allocated tasks 8. The first processing unit 1 is further configured to transmit each of the individual schedules 10a, 10b, 10c to a mobile data communication device 12a, 12b, 12c assigned to the respective one of the mobile resources, that is, the field operation teams. The allocating of the skills 6 to the tasks 8 and equipment 7 is performed by applying optimization algorithms in order to generate the at least one schedule by minimizing the estimated length of travel time and/or travel distance per pre-defined time window while maximizing the number of allocated tasks during that time window.

According to an exemplary embodiment of the present disclosure, the system further includes a second data processing unit 2 which, in this example, is implemented in a second computing device having a processor and/or appropriate processing circuitry. The second data processing unit 2 is configured to continuously pre-process the dynamic data 11 in order to determine which of the street-level data 9, the mobile resources 5 represented mainly by their skills 6 and equipment 7, and the tasks 8 are affected by the dynamic data 11 and to what extent, and to amend the affected data 5, 8, 9 accordingly. Examples for such amendments can include the increasing in a priority-level for certain equipment to be prepared for an expected increased complexity of a task, or the reduction in travel times due to for example bad visibility or partly blocked roads as a result of an accident.

Even further, future tasks can be generated and the capacity of corresponding necessary skills and equipment can be reserved, when certain service requests are expected to increase due to some conditions, where the service requests are, for example, coming as emergency requests only after the damages have occurred or are about to be occurring. In these cases, it is of great value to reserve sufficient buffers of skilled labor, by keeping them as an emergency reserve, by either not assigning them to standard tasks, or by assigning them to filler orders that can be interrupted short-term.

In the following, examples for such future tasks are given:

An approaching heat wave can increase the request for air-conditioning unit repairs by a given percentage.

Heavy rainfall can increase the demand of maintenance for sewage networks and pumping assignments for house cellars, etc.

Snow or ice storm can increase the needs of towing trucks, medical emergency aid and snow-cleaning equipment at major roads, airports and public areas.

Big public events or demonstrations can indicate an increased crime-rate which for a security company can be important to focus more labor on given areas or multiply the workforce by contracting

In other words, the task of the second processing unit 2 is to take the collected dynamic data 11 and to process it such that useful information and knowledge can be extracted from it. It can contain numerous different tasks such as update road work information, do statistical analysis on, for example, the effect of weather on traffic or traffic situations based on weekday and time-of-day, create models for major holiday seasons and further. Furthermore, the second data processing unit 2 could also be able to predict tasks, also called orders, and to predict the type of tasks for certain times of the season combined with location data. The data processing algorithms can work periodically, continuously or event-based, for example, when new data is coming, in order to ensure that the parameters for the resource allocation are always kept up-to-date. The algorithms applied by the processor of the second data processing unit 2 can consist of any functions used in computational intelligence, like neural network applications, evolutionary algorithms, machine learning, data mining, statistical analysis, error correction, model fitting and parameter identification functions.

The trigger event 4 can as well be caused by the second data processing unit 2 as a result of one of the dynamic data signaling for example an emergency which requires immediate action.

By inserting the database 3 between the first and the second data processing units, asynchronous data exchange between these two units is enabled, as they can access the data in the database 3 at any time, without coordination. The input data to the first data processing unit 1 can be collected from the database 3, for example, before every run. In this way, the resource allocation can always rely on being able to access relevant information. As the database 3 can always be expanded and further built upon, it can cover today's as well as tomorrow's needs of resource allocation solutions. It should be noted that the database is a database open to connect to several collaborative systems that can access and provide new information from various sources.

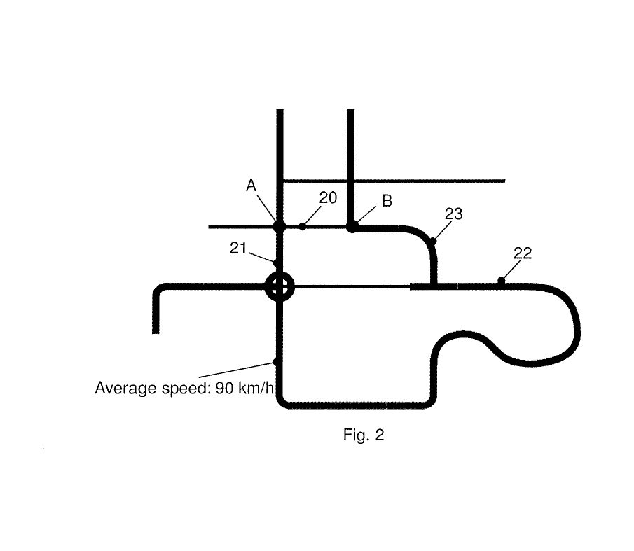

In FIG. 2, an example for a graphic representation of street-level data 9 is shown, according to an exemplary embodiment of the present disclosure. The roads are represented by two-dimensional graphs as in common road maps. To these roads, the following further data can be attached: the expected or estimated average speed along the road; traffic regulations, such as one-way street; and/or the type of the road, indicated here by the thickness of the respective graph, where a thick line can indicate a highway and a thin line can indicate a secondary road or an intra-urban road leading through an inhabited place. A first task is to be performed at location A and a second task is to be performed at location B.

The first data processing unit 1 estimates the travel time between the tasks based on travel distance and expected travel speed and takes it into account during resource allocation.

In known resource allocation systems, instead of using the above described road map or street-level data, the travel distance would be estimated by just using the geographic coordinates of locations A and B to calculate the travel distance through a straight line between the locations. In the example of FIG. 2, the travel distance would accordingly have been calculated to be equal to the length of road 20. In other words, known resource allocation systems do not generate street-by-street level routes as part of the schedule, but instead just provide the schedule in the form of a sequence of geographic locations of the tasks, where the field operation team would then have to use a navigation system to generate the corresponding route.

However, it is important to realize that the quality of the resulting schedule and street-by-street route can be very critical as a poor allocation of mobile resources to tasks can result either in missed appointments, or in an inefficient use of capacity and skills, or in a waste of fuel and, due to that, in unnecessary emissions.

In order to improve the quality of the schedules, it is suggested to use the above described street-level data for calculating the travel times and to include the finding of an optimal route in the optimization of schedules. From the street-level data, the first data processing unit 1 learns that road 20 is a one-way street which is open only in the direction from B to A. Accordingly, the first processing unit 1 would then find the route which leads along the main roads 21, 22 and 23 as the shortest way to travel from A to B. The travel distance for this route, calculated from the geographic coordinates of the roads, is much longer, as is the correspondingly estimated travel time. Accordingly, the schedule generated based on the present disclosure becomes much more realistic and therefore reliable so that it can be ensured that all subsequent appointments and tasks allocated to the field operation team which takes care of the tasks at locations A and B can be met as well. The travel time is estimated taking into account the average speed along each of the roads 21 to 23, wherein the average speed for multiple consecutive roads results in a position-dependent speed profile and wherein additionally a time-dependence can be introduced by pre-defining the average speed for example for different times of the day and/or the week. Alternatively, the first data processing unit 1 can derive the average speed from the street-level data 9 taking into account speed limits attached to the specific road types and possible further traffic restrictions. However, according to an exemplary embodiment, the definition of the street-level data 9 can remain unchanged, independently of which kind of dynamic data 11 are provided. As traffic restrictions can be caused by different real-time events, it is advantageous if the average speed is indeed defined as input to the first processing unit 1, since the second data processing unit 2 can pre-process the different real-time events and reflect their impact on the travel time by adjusting the average speed accordingly. In general, the travel time predictions can be more accurate and meaningful if the related information affecting the normal flow of traffic or a driver's behavior is known in advance.

Examples for dynamic data 11 which can affect the street-level data are given below:

For a given area, the time-dependent traffic patterns can be quite similar, so that mainly the speed parameters therefore must only be adapted to various regions.

Vacation times, especially the start and end of major holidays, have a significant effect on the normal rush hours.

Events such as city marathons, political venues, street festivals or big rock concerts can block streets or part of the city from normal traffic.

Weather dependent conditions can directly affect the traffic and accident rates.

According to an exemplary embodiment, the traffic related data during the most essential travel times can be stored in the database 3 and used by the second data processing unit 2 to statistically evaluate a better travel time for the same distance and, accordingly, adapt the average speed in the street-level data and/or a priority level of certain roads.

There can be bottlenecks, like construction sites blocking one lane of a road, which can cause heavy congestions and can result in an increase in travel time for a 2 km distance from normally 2 minutes up to 30 minutes.

As already pointed out, with the present disclosure, the optimizing of the allocation of orders or tasks to mobile resources is improved by taking advantage of critical information that is publically or privately available through modern communication technologies. In order to provide a system which is open to include as much additional information as is deemed necessary to achieve a desired level of quality of schedules, it is suggested that the central database 3 collects all the information, that the data interface to the first processing unit 1 is standardized by introducing a fixed set of input data 5, 8 and 9 in a pre-defined format, and that the second data processing unit 2 keeps the fixed set of input data 5, 8 and 9 up-to-date by analyzing the dynamic data 11, by deriving conclusions on their impact on the input data 5, 8 and 9 and by adjusting the input data 5, 8 and 9 accordingly.

In this way, the handling and utilization of various real-time data is enabled during allocation of mobile resources. Further, the resource allocation system can be connected to a free choice of different data sources and external information systems providing the real-time data, where already a subset of all available data can be enough to improve current resource allocation systems, as any enhancements on the input data to the first data processing unit 1 can contribute to more robust solutions. As a result, various functionalities can easily be integrated in the system, so that the system can be configured by the end user according to the primary needs. Further, the safety and environmental impact of the mobile units, for example, of the field operation teams, are enhanced, since their schedules are more realistic so that they no longer need to rush from task to task in order to make up for time lost due to poor scheduling and so that unnecessary driving and thereby unnecessary usage of fuel is reduced. The proposed system is more accurate, responsive and predictive as known resource allocation systems.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for automatic allocation of mobile resources to tasks which are to be performed at at least one location distant from the mobile resources, the system comprising:
at least one database configured to store data defining the tasks as well as the mobile resources; and
a computing device containing a first data processing unit which is configured to
wait for a trigger event, and
after having been notified of the trigger event, access the at least one database, allocate the mobile resources to the tasks to generate an individual schedule for at least one of the mobile resources, and transmit each of the individual schedules to a mobile data communication device assigned to the respective one of the mobile resources, wherein:
the at least one database is configured to store
at least one corresponding skill and equipment for each mobile resource,
street-level data defining roads between a current location of the mobile resources and the at least one distant location of the tasks, and
dynamic data which have a potential impact on the performing of the tasks;
the first data processing unit is configured to perform the allocation of the mobile resources by allocating the skills to the tasks and to the equipment, and to generate for the at least one of the mobile resources, as part of each individual schedule, a street-by-street route along the roads to the respectively allocated tasks; and
the system comprises a second data processing unit implemented in one of the computing device and a further computing device, the second data processing unit being configured to continuously pre-process the dynamic data to determine which of the street-level data, the mobile resources and the tasks are affected by the dynamic data and to what extent, and to amend the affected data accordingly.

2. The system according to claim 1, wherein the second data processing unit is configured to introduce a logical link between at least two of the skills, equipment, roads and tasks, and
wherein the first data processing unit is configured to perform the allocating so that the logically linked data are reflected in the individual schedule.

3. The system according to claim 1, wherein the street-level data contain for each of the roads speed-related information corresponding to a specified section of the road, and
wherein the first data processing unit is configured to generate the individual schedule and the corresponding street-by-street route by minimizing at least one of a length of travel time and a travel distance per unified time window while maximizing the number of allocated tasks per the unified time window.

4. The system according to claim 1, wherein the dynamic data include data from a traffic control center about at least one of traffic jams, accidents and construction sites, and
wherein the second data processing unit is configured to identify the roads which are affected by the data from the traffic control center and the extent to which the street-level data corresponding to the identified roads are affected, and to adjust the corresponding street-level data accordingly.

5. The system according to claim 3, wherein the database is configured to store the dynamic data over a pre-defined period of time, and
wherein the second data processing unit is configured to identify from the dynamic data a time-dependent pattern of traffic intensity along the roads, and to amend the street-level data to reflect the pattern of traffic intensity by adjusting the speed-related information accordingly.

6. The system according to claim 3, wherein the dynamic data include data of a traffic related public event, and
wherein the second data processing unit is configured to estimate the impact of the event on the speed-related information, and to identify those roads which will be blocked for any traffic during the event.

7. The system according to claim 3, wherein the dynamic data include weather related data,
wherein the second data processing unit is configured to correspondingly adjust at least one of the speed-related information of affected roads, and a priority ranking of at least one of the equipment and skills, and
wherein the first data processing unit is configured to perform the allocating so that the priority ranking is reflected in the individual schedule.

8. The system according to claim 1, wherein the dynamic data include data on the availability of at least one of fuel and electricity, and
wherein the second data processing unit is configured to adapt a priority ranking of at least one of the tasks and fuel- or electricity driven equipment to the respective availability.

9. The system according to claim 1, wherein the second data processing unit is configured to predict future tasks based on the dynamic data, and
wherein one of the first data processing unit and the second data processing unit is configured to define an appropriate emergency reserve of mobile resources capable of responding to the predicted tasks.

10. The system according to claim 1, wherein the dynamic data include an update on a state of a mobile resource, and
wherein the second data processing unit is configured to determine a resulting impact on any of the skills and/or equipment.

11. The system according to claim 3, wherein the dynamic data include data on the availability of at least one of fuel and electricity, and
wherein the second data processing unit is configured to adapt a priority ranking of at least one of the tasks and fuel- or electricity driven equipment to the respective availability.

12. The system according to claim 3, wherein the second data processing unit is configured to predict future tasks based on the dynamic data, and
wherein one of the first data processing unit and the second data processing unit is configured to define an appropriate emergency reserve of mobile resources capable of responding to the predicted tasks.

13. The system according to claim 3, wherein the dynamic data include an update on a state of a mobile resource, and
wherein the second data processing unit is configured to determine a resulting impact on any of the skills and/or equipment.

14. A method for computer-implemented automatic allocation of mobile resources to tasks which are to be performed at at least one location distant from the mobile resources, the method comprising:
storing data defining the tasks as well as the mobile resources in at least one database;
waiting for a trigger event by a first data processing device;
after having been notified of the trigger event, in the first data processing device, accessing the at least one database, allocating the mobile resources to the tasks to generate an individual schedule for at least one of the mobile resources, and transmitting each of the individual schedules to a mobile data communication device assigned to the respective one of the mobile resources;
storing in the at least one database
at least one corresponding skill and equipment for each mobile resource,
street-level data defining roads between a current location of the mobile resources and the at least one distant location of the tasks, and
dynamic data which have a potential impact on the performing of the tasks;
performing, in the first data processing device, the allocating of the mobile resources by allocating the skills to the tasks and to the equipment, and by generating for the at least one of the mobile resources as part of each individual schedule a street-by-street route along the roads to the allocated tasks; and
continuously pre-processing, in a second data processing device, the dynamic data to determine which of the street-level data, the mobile resources and the tasks are affected by the dynamic data and to what extent, and to amend the affected data accordingly.
